(19) United States
(12) Patent Application Publication
(10) Pub. No.: US 2018/0027777 A1
(43) Pub. Date: Feb. 1, 2018

(54) WATER CONSUMPTION SENSORS AND SYSTEMS FOR EQUINE APPLICATIONS

(71) Applicant: Stablesense, Inc., Ithaca, NY (US)

(72) Inventors: Caitlin Parrucci, Ithaca, NY (US); Shannon Mackey, Ithaca, NY (US)

(21) Appl. No.: 15/660,419

(22) Filed: Jul. 26, 2017

Related U.S. Application Data
(60) Provisional application No. 62/366,893, filed on Jul. 26, 2016.

(51) Int. Cl. A01K 29/00; A01K 7/02; G05D 9/12

(52) U.S. Cl. CPC A01K 29/005; G05D 9/12; A01K 7/02

(57) ABSTRACT

Water consumption monitors adapted for use in equine applications are provided. In some embodiments, an outer casing is provided that is separably coupled to a wall mount. A bucket retention arm is coupled to the wall mount and extends distally from the wall mount through the outer casing. A cantilever sensor is disposed within the outer casing and is operably coupled to the bucket retention arm. The cantilever sensor is adapted to detect a force on the bucket retention arm. A transmitter is operably coupled to the cantilever sensor and is adapted to transmit data regarding the force on the bucket retention arm.

### CROSS-REFERENCE TO RELATED APPLICATIONS

This application claims the benefit of U.S. Provisional Application No. 62/366,893, filed Jul. 26, 2016, which is hereby incorporate by reference in its entirety.

### BACKGROUND

Embodiments of the present invention relate to water level monitors, and more specifically, to water consumption monitors adapted for use in equine applications.

### BRIEF SUMMARY

According to embodiments of the present disclosure, a device and system for monitoring water consumption is provided. In some embodiments, an outer casing is provided that is separably coupled to a wall mount. A bucket retention arm is coupled to the wall mount and extends distally from the wall mount through the outer casing. A cantilever sensor is disposed within the outer casing and is operably coupled to the bucket retention arm. The cantilever sensor is adapted to detect a force on the bucket retention arm. A transmitter is operably coupled to the cantilever sensor and is adapted to transmit data regarding the force on the bucket retention arm.

### BRIEF DESCRIPTION OF THE SEVERAL VIEWS OF THE DRAWINGS

FIG. 1 depicts an outer casing of a water consumption sensor according to a first embodiment of the present disclosure.

FIG. 2 depicts a wall mount of a water consumption sensor according to a first embodiment of the present disclosure.

FIG. 3 is a front view of an outer casing of a water consumption sensor according to a first embodiment of the present disclosure.

FIG. 4 depicts the exterior of a water consumption sensor according to a second embodiment of the present disclosure.

FIG. 5 is a front view of the exterior of a water consumption sensor according to a second embodiment of the present disclosure.

FIG. 6 is a side view of a water consumption sensor according to a second embodiment of the present disclosure.

FIG. 7 depicts a water consumption sensor according to a second embodiment of the present disclosure in use.

FIG. 8 depicts a water consumption sensor according to a third embodiment of the present disclosure.

FIG. 9 is a side view of a water consumption sensor according to a third embodiment of the present disclosure.

FIG. 10 is a bottom view of a water consumption sensor according to a third embodiment of the present disclosure.

FIG. 11 is a perspective view of a water consumption sensor according to a third embodiment of the present disclosure.

FIG. 12 depicts a water consumption sensor according to a fourth embodiment of the present disclosure.

FIG. 13 is a back view of a water consumption sensor according to a fourth embodiment of the present disclosure.

FIG. 14 is a front view of a water consumption sensor according to a fourth embodiment of the present disclosure.

FIG. 15 is a perspective view of a water consumption sensor according to a fourth embodiment of the present disclosure.

FIG. 16 depicts a water consumption sensor according to a fourth embodiment of the present disclosure in use.

FIG. 17 depicts a water consumption sensor according to a fifth embodiment of the present disclosure.

FIG. 18 is a front view of a water consumption sensor according to a fifth embodiment of the present disclosure.

FIG. 19 is a perspective view of a water consumption sensor according to a fifth embodiment of the present disclosure.

FIG. 20 is a back view of a water consumption sensor according to a fifth embodiment of the present disclosure.

FIG. 21 depicts a water consumption sensor according to a fifth embodiment of the present disclosure in use.

FIG. 22 depicts the interior of a water consumption sensor according to a fifth embodiment of the present disclosure.

FIG. 23 depicts a water consumption sensor according to a sixth embodiment of the present disclosure.

FIG. 24 depicts the interior of a water consumption sensor according to a sixth embodiment of the present disclosure.

FIG. 25 depicts a water consumption sensor according to a sixth embodiment of the present disclosure.

FIG. 26 depicts a water consumption sensor according to a seventh embodiment of the present disclosure.

FIG. 27 depicts the interior of a water consumption sensor according to a seventh embodiment of the present disclosure.

FIG. 28 depicts a system for water consumption monitoring according to embodiments of the present disclosure.

FIG. 29 depicts a computing node according to embodiments of the present disclosure.

### DETAILED DESCRIPTION

Hydration is an important indicator of equine health. A horse's water intake is directly related to his eating behavior, digestion, and overall wellness. Colic is the most common cause of death in horses, and there are numerous other diseases and disorders which cause abnormal drinking behavior.

Using existing systems, it is difficult to accurately and consistently measure water intake, whether using buckets or automatic waterers. Accordingly, the present disclosure provides water consumption sensors and water monitoring systems that allow water intake to be recorded and analyzed. By collecting water consumption data proactively, timely intervention becomes possible. In this way, the serious health issues are detected early and may be addressed before they become more severe.

In various embodiments of the present disclosure, a water consumption monitoring system is provided that records real-time information about water consumption and sends alerts to horse owners when a horse is behaving abnormally. A water consumption sensor device attaches to the horse's water bucket and measures the horse's water consumption throughout the day. This information is sent to a user interface such as a mobile application or a web interface, allowing owners, barn managers and trainers to track and analyze their horses' water consumption remotely.

According to various embodiment, a water consumption sensor includes an outer casing, a wall mount, a bucket retention arm, and a sensor. In some embodiments, a water consumption sensor further includes a radio for communication with central hub.

According to various embodiments, the outer casing is adapted to the horse barn environment. In some embodiments, the outer casing has a low profile, so that it rests close to the wall in order not to obstruct a water bucket. Accordingly, in some embodiments, the outer casing has a depth of at about three inches or less. In some embodiments, the outer casing has a depth of about two inches or less. In some embodiments, the outer casing is elongated so that a horse cannot fit the casing in his mouth. Accordingly, in some embodiments, the outer casing has a height of at least about four inches. In some embodiments, the outer casing has a height of at least about five inches. In some embodiments, the outer casing has a height of at least about six inches. In some embodiments, the outer casing has a height of at least about seven inches.

In order to avoid injury, in some embodiments, the outer casing has rounded corners. In some embodiments, the outer casing has no outward facing corners. In some embodiments, the outer casing is substantially dome shaped.

In order to avoid damage by interaction with a horse, in some embodiments, the outer casing is impact proof. In some embodiments, the outer casing is bite resistant. In some embodiments, the outer casing supports the weight of a water bucket. However, in other embodiment described below, the weight of a water bucket is borne by the wall mount.

In some embodiments, the outer casing is water resistant. In some embodiments, it is watertight. In other embodiments, internal electronics are waterproofed, and thus the outer casing need not be completely watertight.

In some embodiments, the outer casing includes an opening for a bucket retention member. As described below, the bucket retention member may be an arm or a loop.

Various materials are suitable for the outer casing, including plastics, metals, ceramics, wood, and fiberglass. In embodiments having a metal or otherwise radiopaque outer casing, an additional opening may be provided for an external antenna. Plastics that may be used to form the outer casing according to various embodiments include but are not limited to Polyester, Polyethylene terephthalate, Polyethylene, High-density polyethylene, Polyvinyl chloride, Polyvinylidene chloride, Low-density polyethylene, Polypropylene, Polystyrene, High impact polystyrene, Polyamides, Acrylonitrile butadiene styrene, Polyethylene/Acrylonitrile Butadiene Styrene, Polycarbonate, Polycarbonate/Acrylonitrile Butadiene Styrene, Polyurethanes, Maleimide/bismaleimide, Melamine formaldehyde, Plastarch material, Phenolics, Polyepoxide, Polyetheretherketone, Polyetherimide, Polyimide, Polylactic acid, Polymethyl methacrylate, Polytetrafluoroethylene, Urea-formaldehyde, Furan, Silicone, and Polysulfone. Metals that may be used to form the outer casing according to various embodiments include but are not limited to aluminum, iron, stainless steel, and titanium. In some embodiments, a combination of materials may be used, for example a wooden front may be coupled to a metallic back to provide increased durability or aesthetics.

According to various embodiments, a wall mount is provided. In some embodiments, the wall mount is integral to the outer casing. In other embodiments, the wall mount is separable from the outer casing. In such embodiments, the casing may fasten to a wall separately from the wall mount. In other such embodiments, the outer casing may fasten to the wall mount. In some embodiments, the wall mount attaches to a wall using integral bolts, screw, nails, or comparable fasteners. In other embodiments, mounting holes are provided for the passage of bolts, screw, nails, or comparable fasteners. In yet other embodiments, the wall mount is adapted to couple to a pre-mounted wall plate, hook, or other attachment point. As noted above, in some embodiments, a bucket retention arm is affixed to the wall mount so as to transmit force to the wall instead of to the outer casing. In some embodiments, a wall mount is a mounting plate, while in some embodiments, a wall mount is a hook, loop, or other connector adapted to couple the sensor device to, e.g., a wire, pipe, or pre-existing hook on or about a wall.

According to various embodiments, a bucket retention arm is provided. In some embodiments, the bucket retention arm is affixed to the wall mount, and extends distally through the outer casing. In some embodiments, the bucket retention arm includes a recess to retain a bucket handle between the outer casing and the distal end of the retention arm. In some embodiments, the bucket retention arm includes a bump, hook, loop, or other feature extending radially outwards from the retention arm and adapted to retain a bucket handle between the outer casing and the distal end of the retention arm. In some embodiments, bucket retention arm includes a closure or clasp that is adapted to prevent a bucket handle from sliding out of the recess or sliding over the bump. In some embodiments, the distal end of the bucket retention arm includes an open or closed loop adapted to fit around the lip of a bucket and hold it in place at the distal end of the retention arm.

In some embodiments, the bucket retention arm is adapted to transmit the weight of a bucket to a wall mount rather than to the casing. As set forth further below, the retention arm is operably coupled to a sensor. In some embodiments, the retention arm is disposed substantially perpendicular to a wall. In other embodiments, the retention arm is disposed at an angle ranging from about 30° to the wall to about 90° to the wall. In some embodiments, the retention arm is disposed at an angle ranging from 0° degrees to 90° degrees to the wall in shear loading. In other embodiments, the retention arm is disposed parallel to the wall so that the retention arm is loaded in tension.

In some embodiments, the length of the retention arm is short enough that bucket does not extend into room such that it can be bumped and spilled excessively. Accordingly, in some embodiments, the retention arm extends about two inches or less from the outer casing. Similarly, in some embodiments, the retention arm is at a height adapted to prevent the bucket dropping low enough for a horse to get a leg in into the bucket.

In some embodiments, a substantially vertical retention arm is included in place of or in addition to a substantially horizontal retention arm. In such embodiments, the substantially vertical retention arm extends substantially vertically through the outer casing.

According to various embodiments, a sensor is provided. In some embodiments, the sensor is a cantilever sensor that is operably coupled to the retention arm and adapted to sense changes in weight of the bucket due to increase or decrease of water level. In some embodiments, the bucket when full of water weighs up to 40 pounds. Accordingly, a suitable cantilever sensor should maintain accuracy while continuously bearing about 40 pounds. Moreover, a suitable cantilever sensor should maintain accuracy under sudden excessive loads, such as if a bucket is dropped or if a horse pushes on the bucket.

In other embodiments, the sensor is a spring sensor. In such embodiments, the sensor is operably coupled to the retention arm and tension on or length of a spring is measured to derive weight. In such embodiments, a sufficiently resilient spring is required to avoid permanent deformation under continuous load.

In other embodiments, the sensor is a proximity sensor, such as capacitive sensor, capacitive displacement sensor, Doppler effect sensor, eddy-current sensor, inductive sensor, laser rangefinder, magnetic sensor, magnetic proximity fuse, passive optical sensor, passive thermal infrared sensor, photocell sensor, sensor, sonar, ultrasonic sensor, or Hall effect sensor. In such embodiments, a proximity sensor is coupled to the retention arm and trained into a bucket. The height of water in the bucket is determined by the water level proximity to the sensor.

In some embodiments, the sensor is a pressure sensor. In such embodiments, the pressure sensor is coupled to the retention arm and is adapted to detect downward pressure of a bucket handle.

In some embodiments, the sensor is a moisture sensor. In such embodiments, the moisture sensor is elongated and extends into a bucket from the retention arm. The water level is detected based on where moisture is detected. In some embodiments, a plurality of moisture sensors are arrayed on the bucket wall. In some embodiments, one or more potentiometers is arrayed in or along the bucket in detect a water level.

It will be apparent that given the volume and profile of a bucket, sensor data related to water level may be readily converted into a volume measurement. It will also be apparent that given a tare weight of a bucket and a total weight, that sensor data related to weight may be readily converted into a volume measurement.

According to various embodiments, a water consumption sensor continuously monitors water level. In some embodiments, the water level is transmitted to a central hub. In some embodiments, transmission is over wire. In other embodiments, it is wireless. In some embodiments, water level readings are transmitted on a regular schedule, e.g., once a minute, once every 20 minute, once an hour. In other embodiments, the transmission schedule varies based on the current water level reading. For example, once a water level dropped to a predetermined level, the transmission frequency may increase. In another example, no transmission is made until the water level drops to a predetermined level. In some embodiments, the transmission schedule varies based on the current rate of change of the water level reading. In some embodiments, transmission is unscheduled, and instead is made whenever a sufficient change is registered. In some embodiments, a local event detection is performed based on the sensor data, e.g., hay in water, bucket spilled, water consumption critically low, bucket filled. This event is then transmitted to a central hub instead of or in addition to the water level data.

In some embodiments, wireless transmission is provided via Bluetooth or other Personal Area Network technologies. In various embodiments, an antenna is included inside the sensor or outside the sensor. In various wireless embodiments, wireless transmission is provided via radio, while in various embodiments, wireless transmission is provided via infrared. Infrared transmission may be accomplished using various standards known in the art such as provided by IrDA. Radio transmission may be accomplished using various standards known in the art such LoRaWAN, Cellular data, and WiFi.

According to various embodiments, a hub is provided. A hub may be deployed in a barn or otherwise near to deployed sensors in order to aggregate sensor data. In some embodiments, the hub receives data over wire, and in some embodiments it receives data wirelessly. In some embodiments, the hub analyses the sensor data. For example, event detection may be performed based on the sensor data, e.g., hay in water, bucket spilled, water consumption critically low, bucket filled. In some embodiments, the hub relays data over conventional network, e.g., to a remote database via the internet. In some embodiments, the hub provides a local alerts based on event detection, e.g., a warning light on a control panel indicating a spilled bucket.

In some embodiments, a hub is omitted, and each sensor connects via existing wired or wireless infrastructure directly to a network such as the internet. In such embodiments, the sensor communicates directly with a remote server or a remote client, without the need for an intermediating hub.

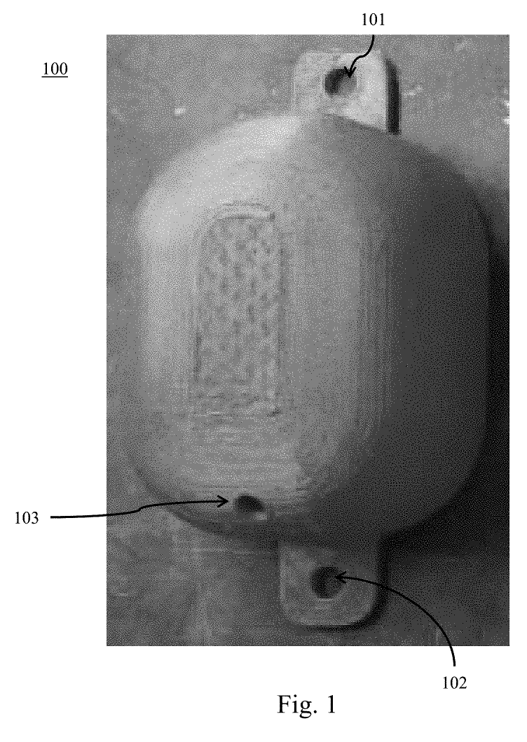

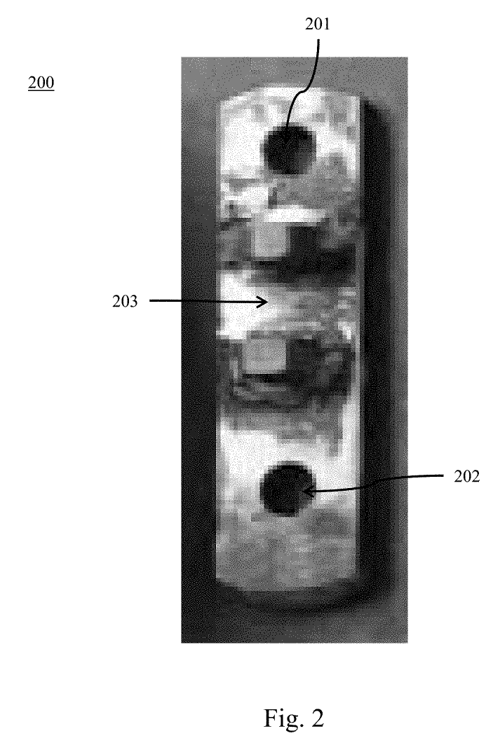

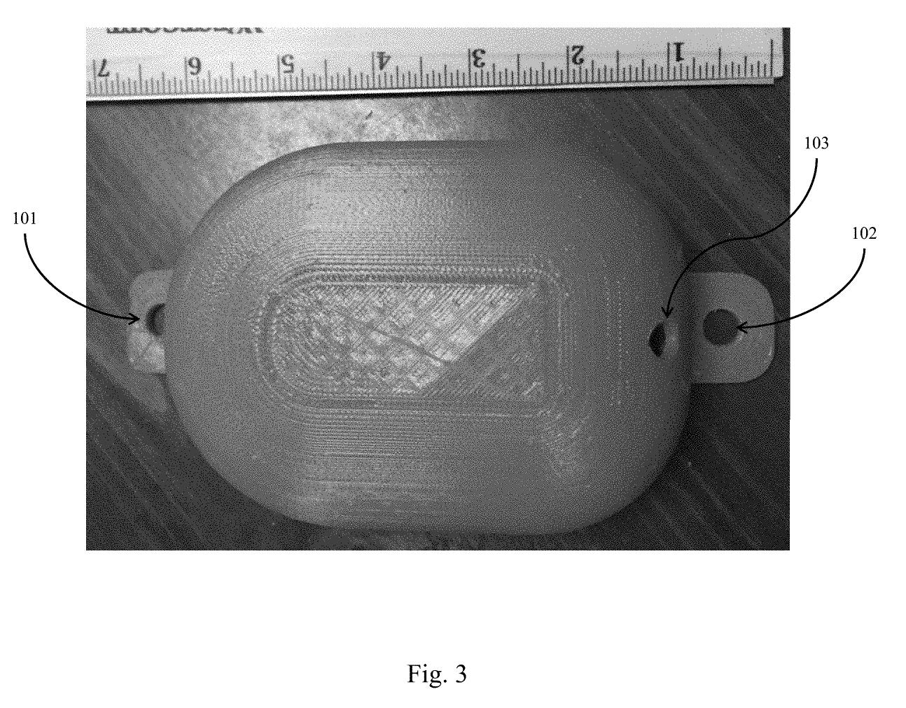

With reference now to FIGS. 1-3, a first exemplary embodiments of a water consumption sensor is depicted. Water consumption sensor includes outer casing 100. Outer casing 100 includes openings 101 . . . 102 adapted for a fastener such as a bolt, screw, or nail to affix outer casing 100 to wall or in some embodiments to a wall mount. Outer casing 100 includes opening 103 adapted for a bucket retention arm to extend distally through outer casing 100. Wall mount 200 includes openings 201 . . . 202 adapted for a fastener such as a bolt, screw, or nail to affix wall mount 200 to wall. Retention arm coupling 203 is adapted to anchor a bucket retention arm and sensor to wall mount 200. In some embodiments, outer casing is about 5.5 inches in height, about 4 inches in width, and about 2 inches in depth.

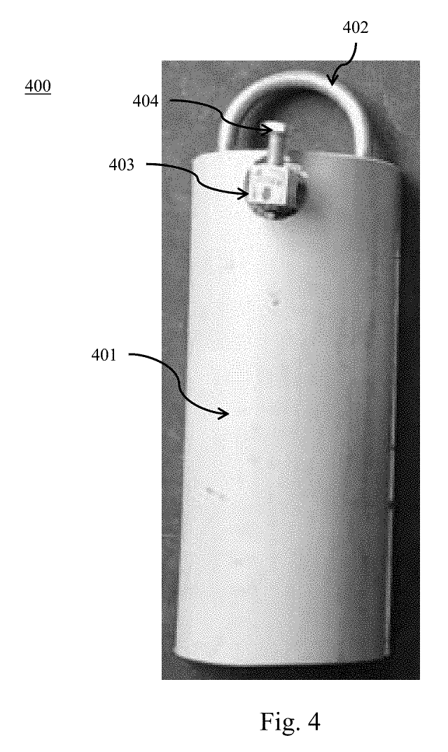

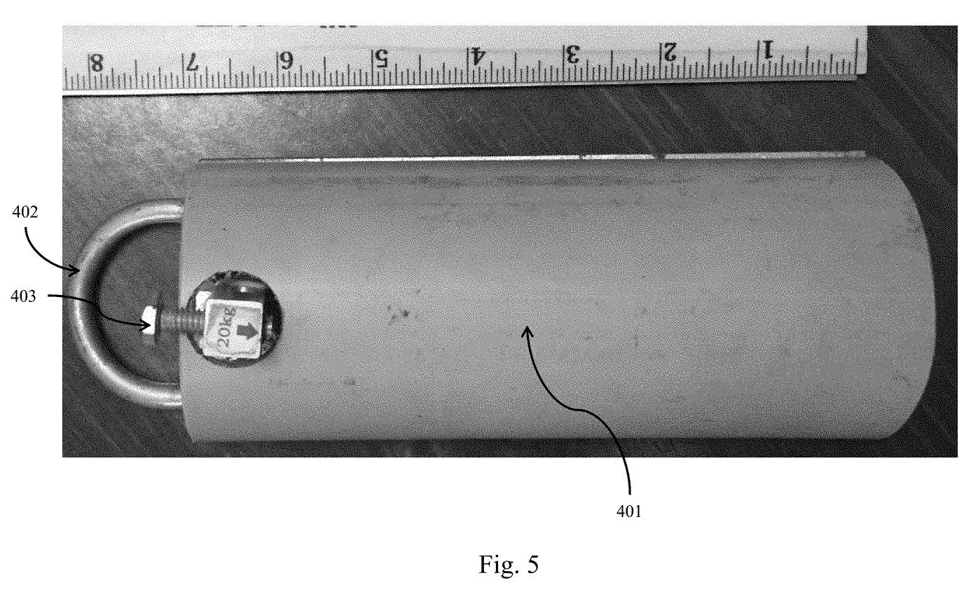

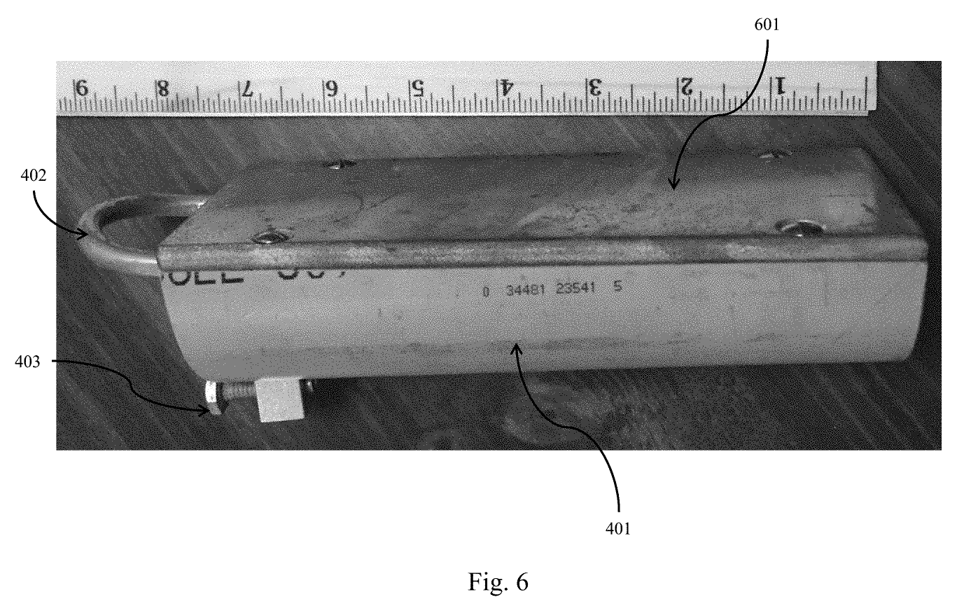

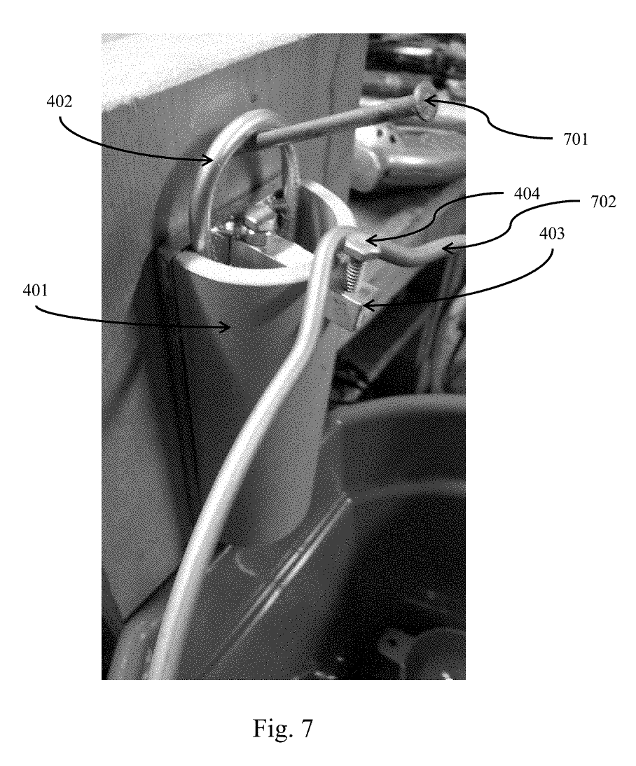

With reference now to FIGS. 4-7, a second exemplary embodiments of a water consumption sensor is depicted. Water consumption sensor 400 includes semi-cylindrical outer casing 401. Wall mount 402 is a roughly semicircular loop adapted to fit over a hook, bolt, nail, or other mount point, such as, e.g., nail 701. Extending through outer casing 401 is bucket retention arm 403. Bucket retention arm 403 includes bolt 404, which is adapted to prevent a bucket handle, e.g., handle 702, from sliding off of bucket retention arm 403. Semi-cylindrical outer casing 401 has a substantially flat back 601 adapted to rest substantially flush with a wall.

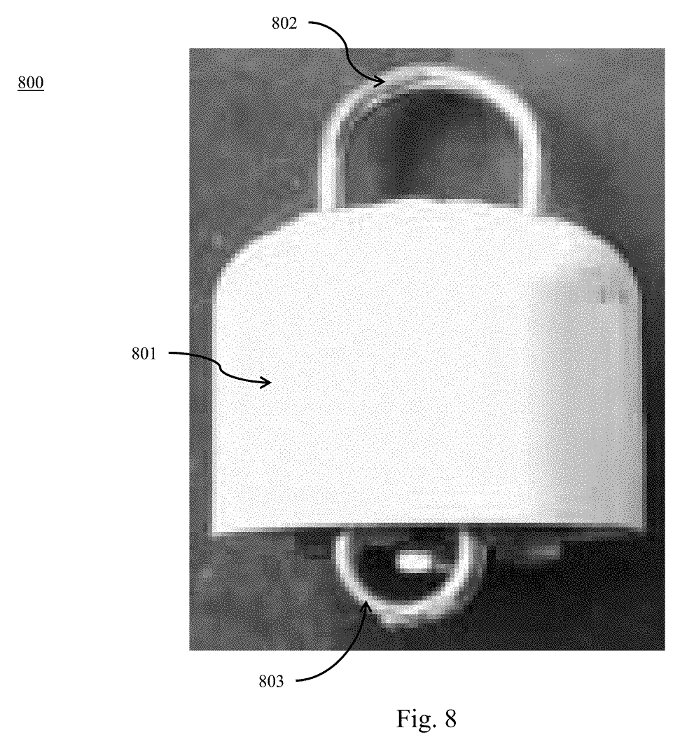

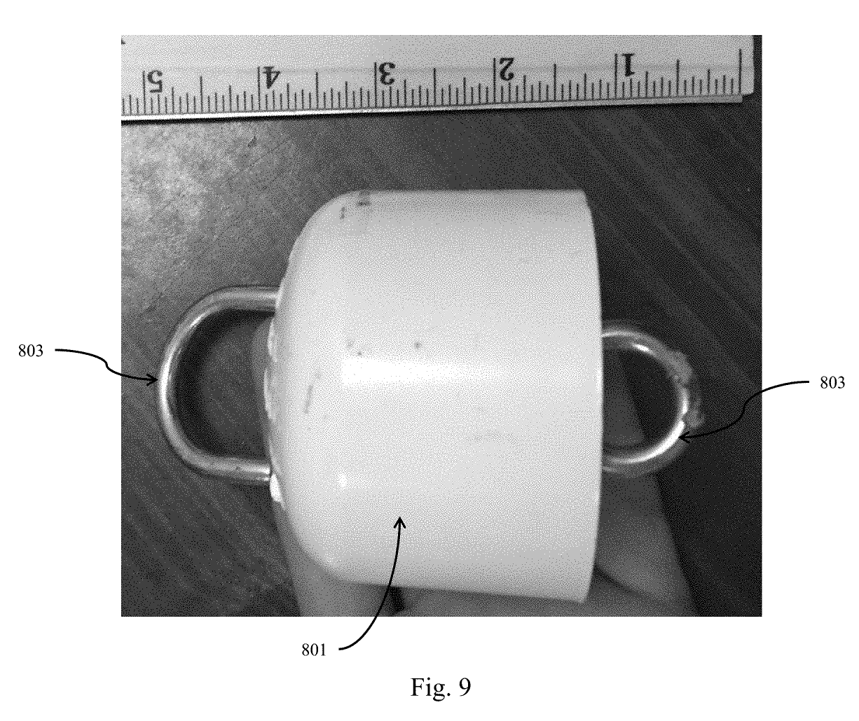

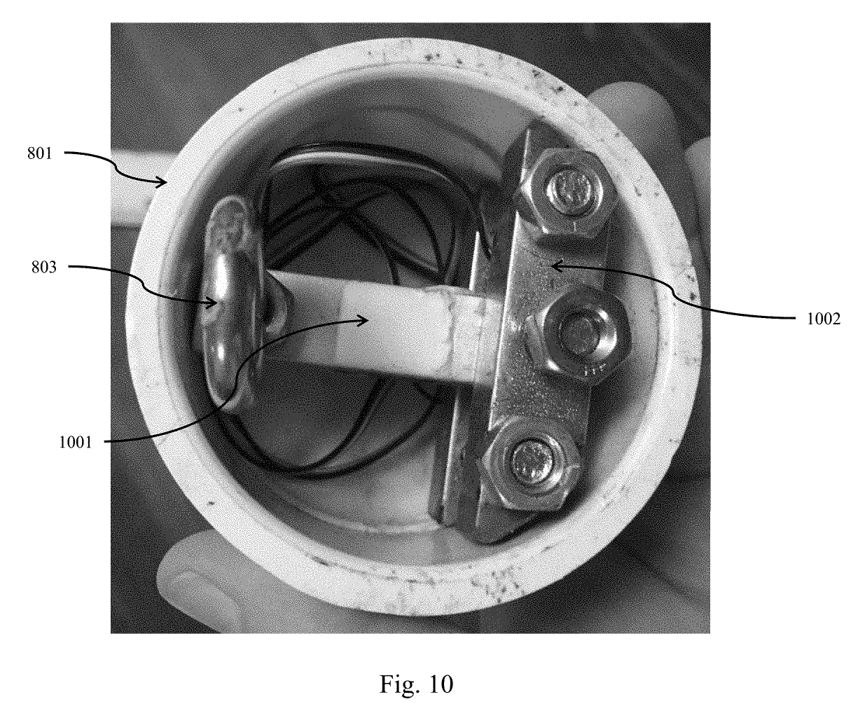

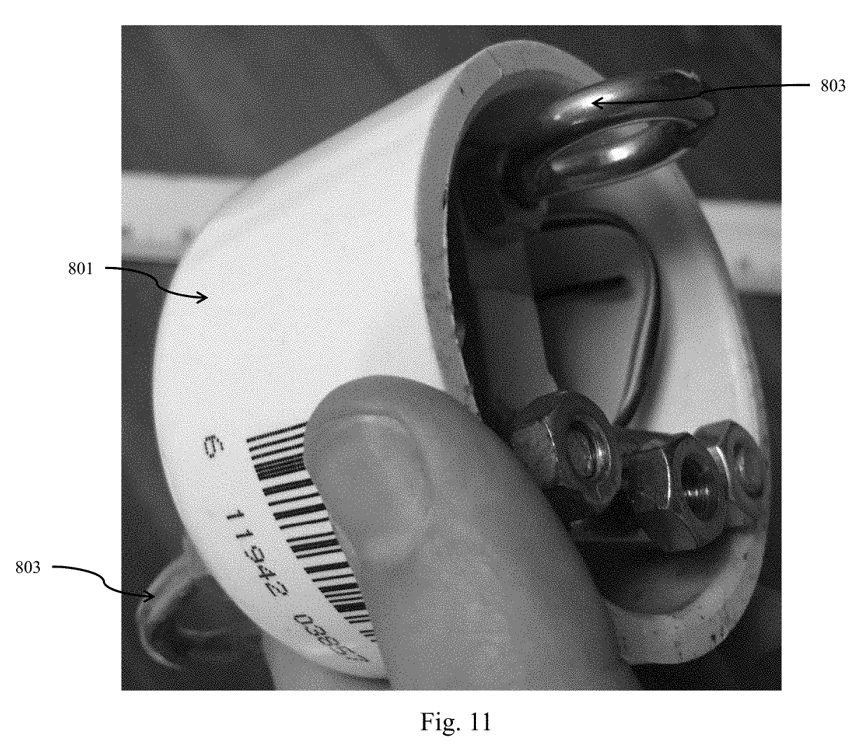

With reference now to FIGS. 8-11, a third exemplary embodiments of a water consumption sensor is depicted. Water consumption sensor 800 includes outer casing 801. Wall mount 802 is a roughly semicircular loop adapted to fit over a hook, bolt, nail, or other mount point. Extending substantially vertically through outer casing 801 is bucket retention arm 803. Bucket retention arm 803 includes a closed loop, which is adapted to receive a hook, carabiner, or other connector and in turn retain a bucket handle. Bucket retention arm 803 is coupled to one end of cantilever sensor 1001, which in turn is coupled to support 1002. Support 1002 is coupled to wall mount 803.

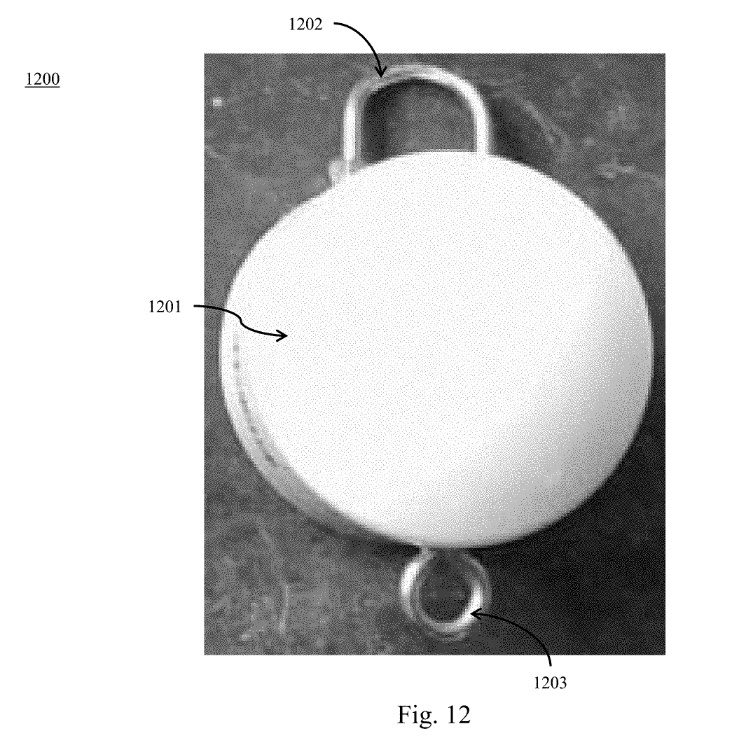

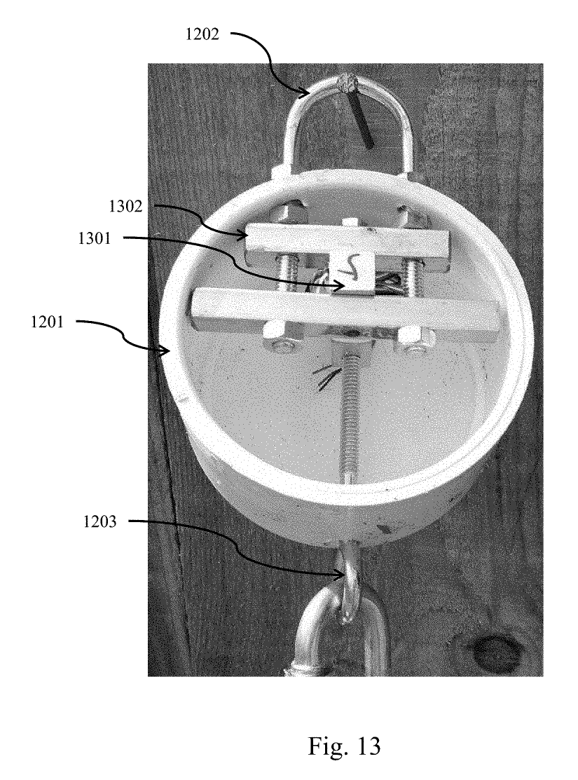

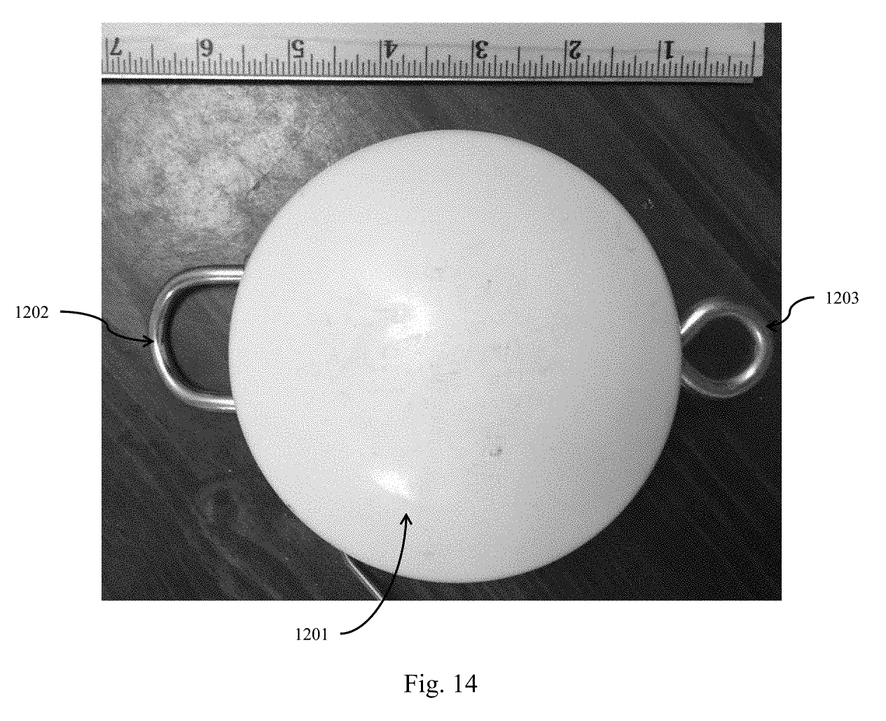

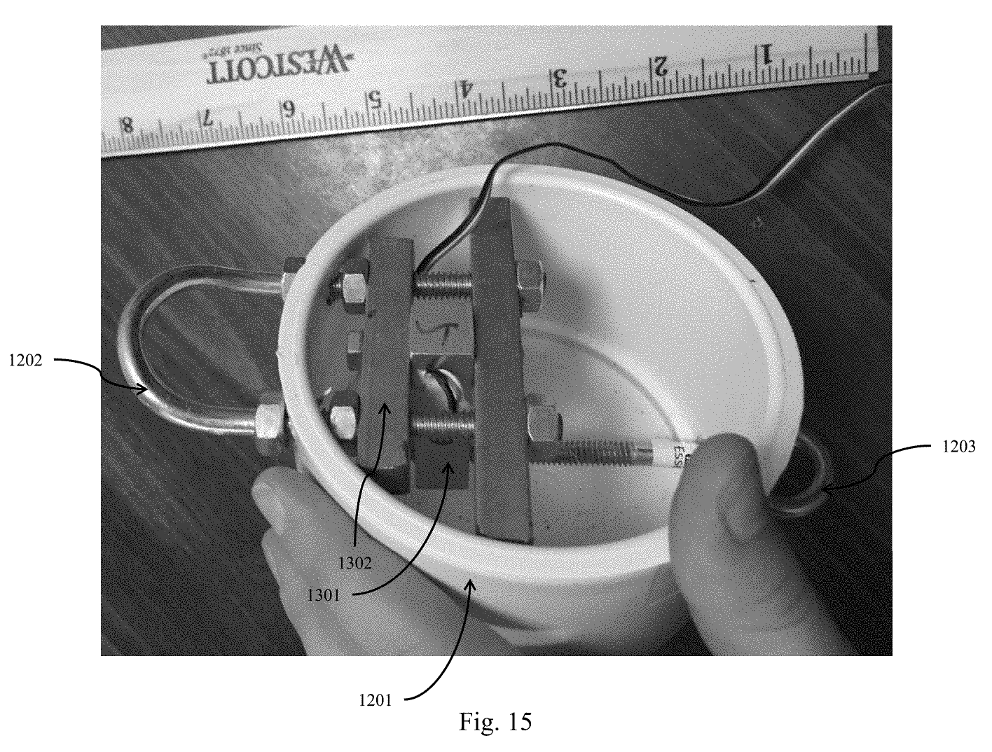

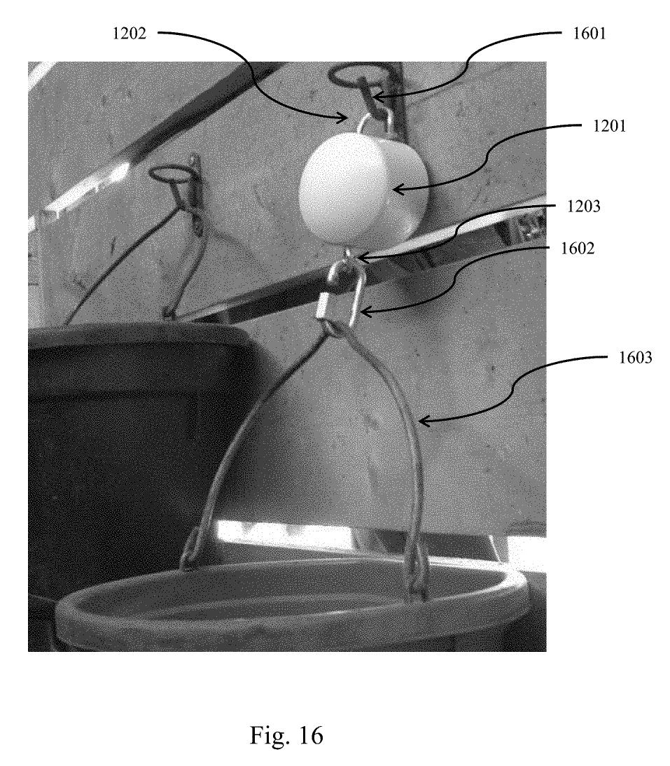

With reference now to FIGS. 12-16, a fourth exemplary embodiments of a water consumption sensor is depicted. Water consumption sensor 1200 includes outer casing 1201. Wall mount 1202 is a roughly semicircular loop adapted to fit over a hook, bolt, nail, or other mount point, such as, e.g., hook 1601. Extending substantially vertically through outer casing 1201 is bucket retention arm 1203. Bucket retention arm 1203 includes a closed loop, which is adapted to receive a hook, carabiner, or other connector, e.g., carabiner 1602, and in turn retain a bucket handle, e.g., handle 1603. Bucket retention arm 1203 is coupled to one end of cantilever sensor 1301, which in turn is coupled to support 1302. Support 1302 is coupled to wall mount 1202.

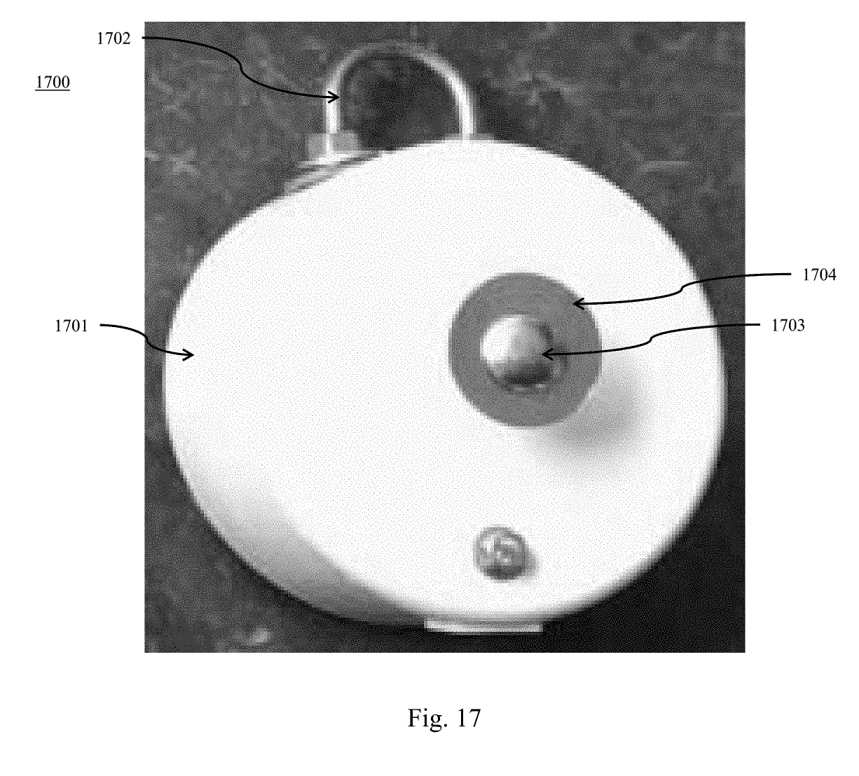

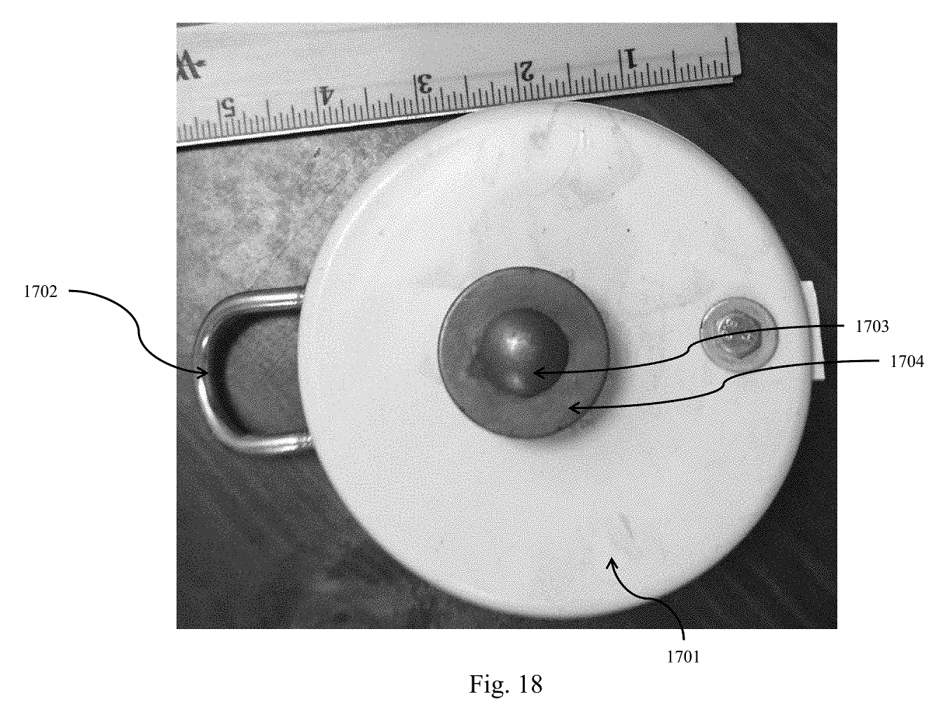

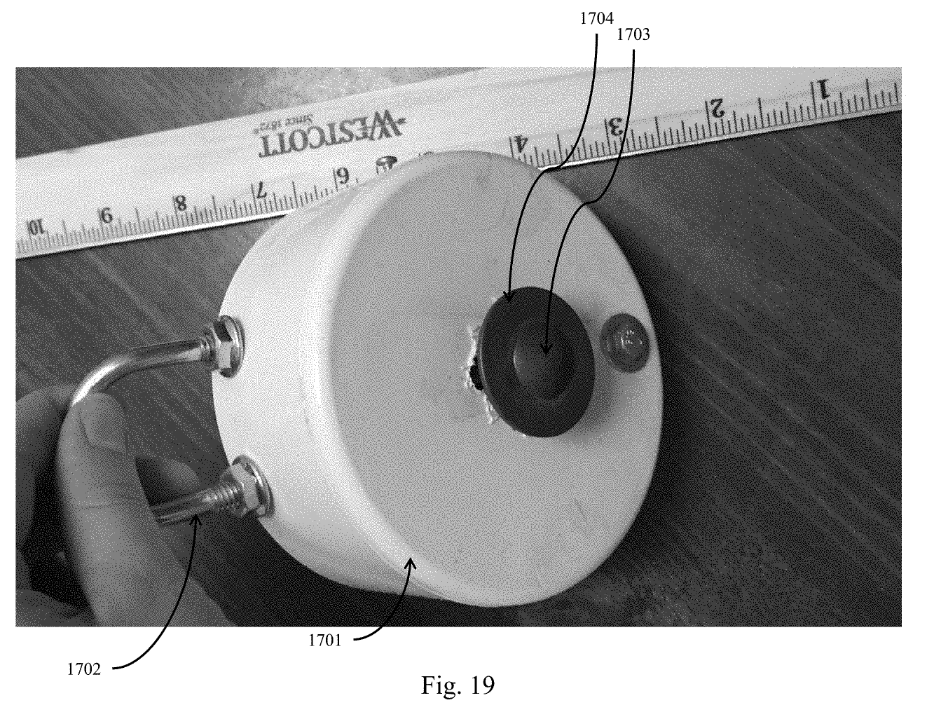

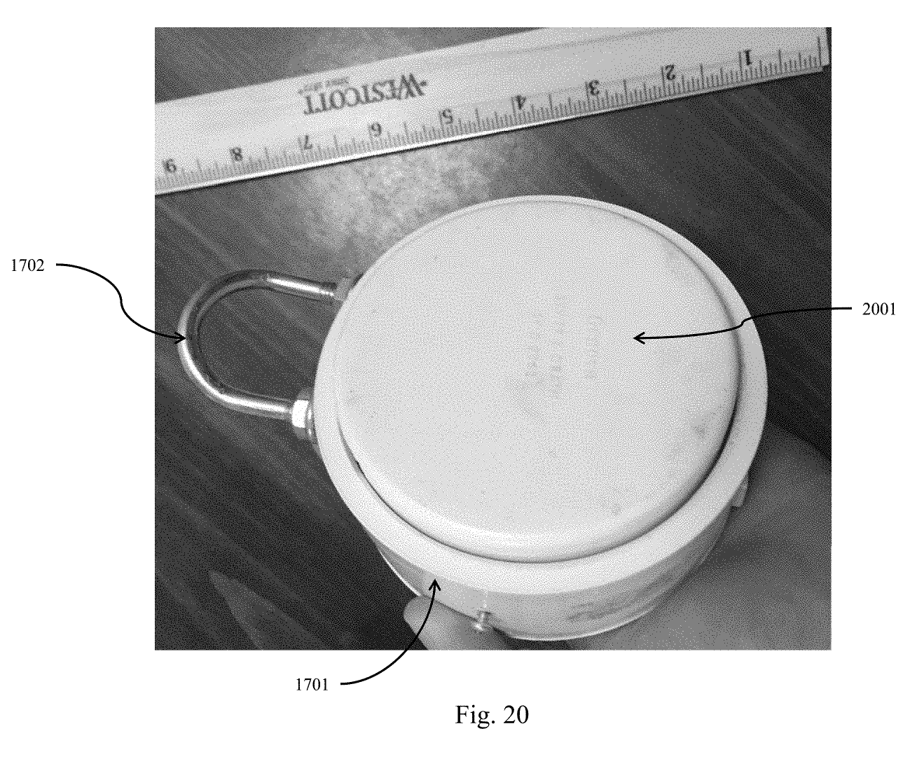

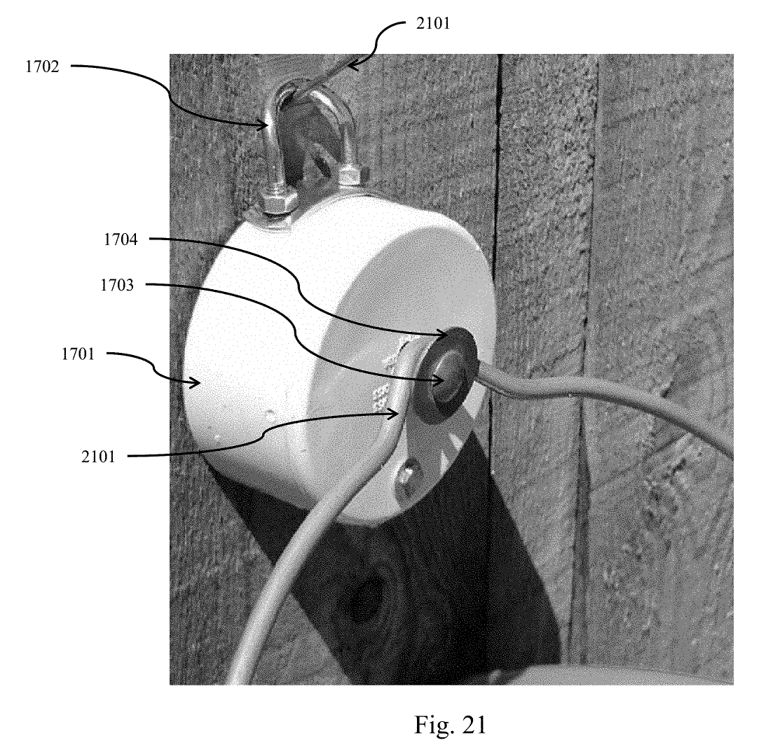

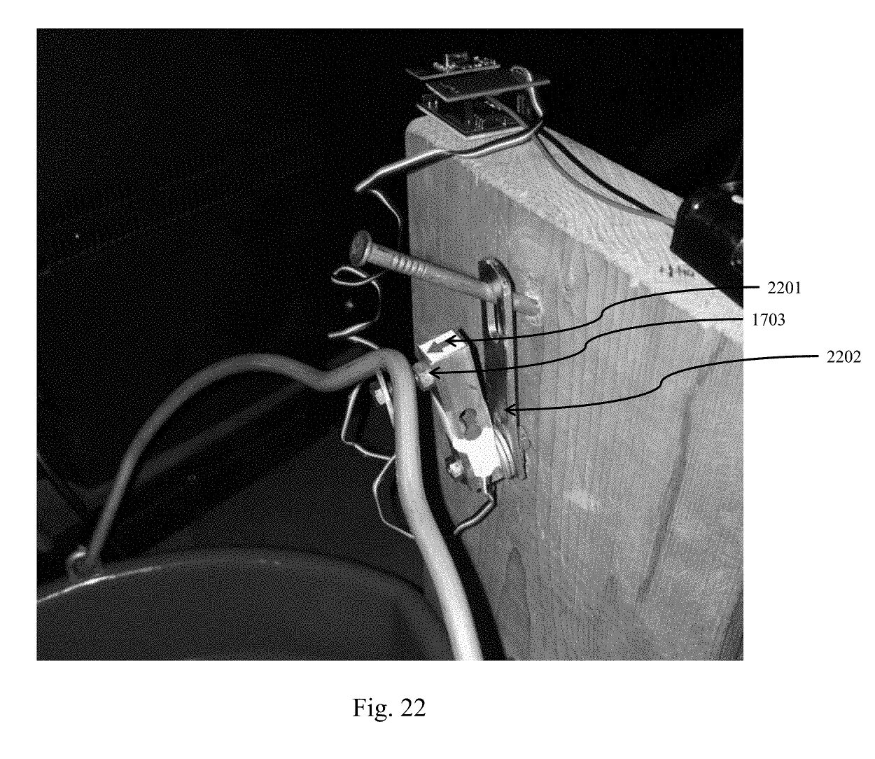

With reference now to FIGS. 17-22, a fifth exemplary embodiments of a water consumption sensor is depicted. Water consumption sensor 1700 includes outer casing 1701. Outer casing 1701 includes a substantially flat back 2001 adapted to rest substantially flush with a wall. In some embodiments, back 2001 is padded. Wall mount 1702 is a roughly semicircular loop adapted to fit over a hook, bolt, nail, or other mount point, such as, e.g., nail 2101. Extending substantially horizontally through outer casing 1701 is bucket retention arm 1703. Bucket retention arm 1703 includes a substantially disc shaped portion 1704 extending radially outward from retention arm 1703, which is adapted to retain a bucket handle, e.g., handle 1603. Bucket retention arm 1703 is coupled to one end of cantilever sensor 2201, which in turn is coupled to support 2202. Support 1302 is coupled to wall mount 1702.

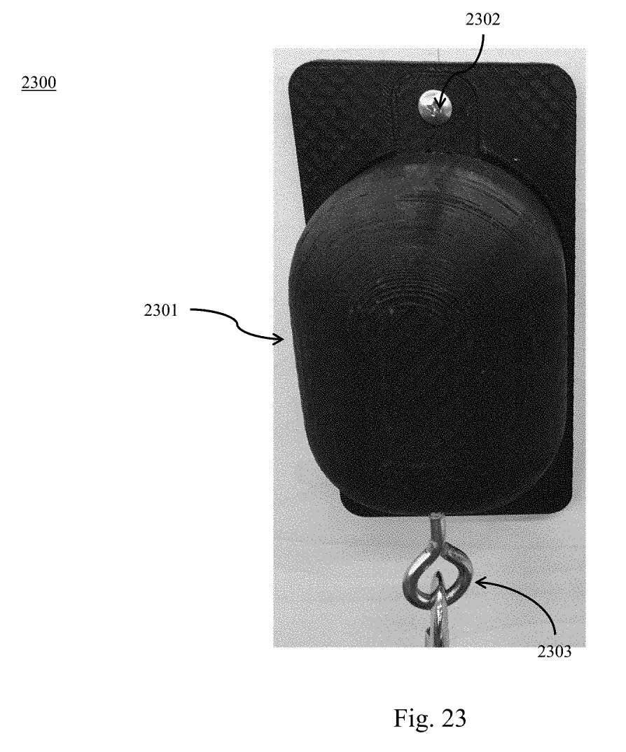

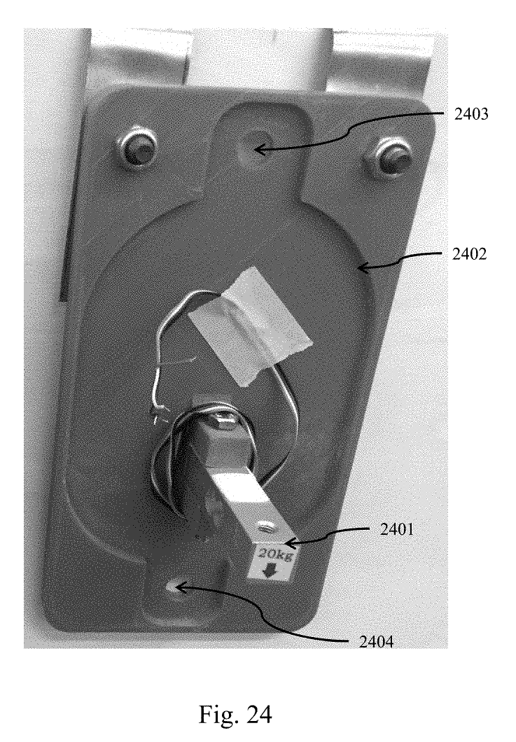

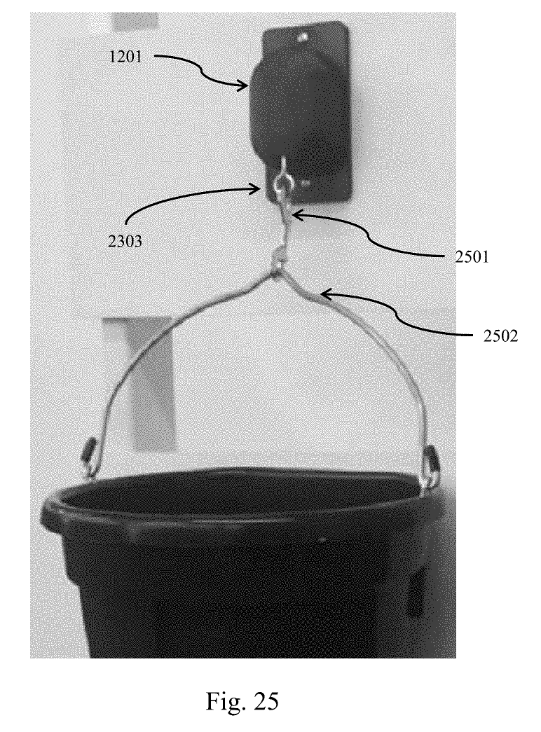

With reference now to FIGS. 23-25, a sixth exemplary embodiments of a water consumption sensor is depicted. Water consumption sensor 2300 includes outer casing 2301. Outer casing 2301 includes openings 2302 adapted for a fastener such as a bolt, screw, or nail to affix outer casing 2301 to wall mount 2401. Extending substantially vertically through outer casing 2301 is bucket retention arm 2303. Bucket retention arm 2303 includes a closed loop, which is adapted to receive a hook, carabiner, or other connector, e.g., hook 2501, and in turn retain a bucket handle, e.g., handle 2502. Bucket retention arm 2303 is coupled to one end of cantilever sensor 2402, which in turn is coupled to wall mount 2401. Wall mount 2401 includes openings 2403 . . . 2404 adapted for a fastener such as a bolt, screw, or nail to affix wall mount 2401 to wall.

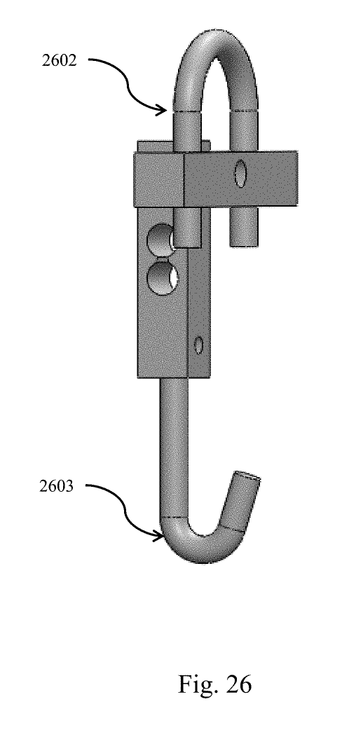

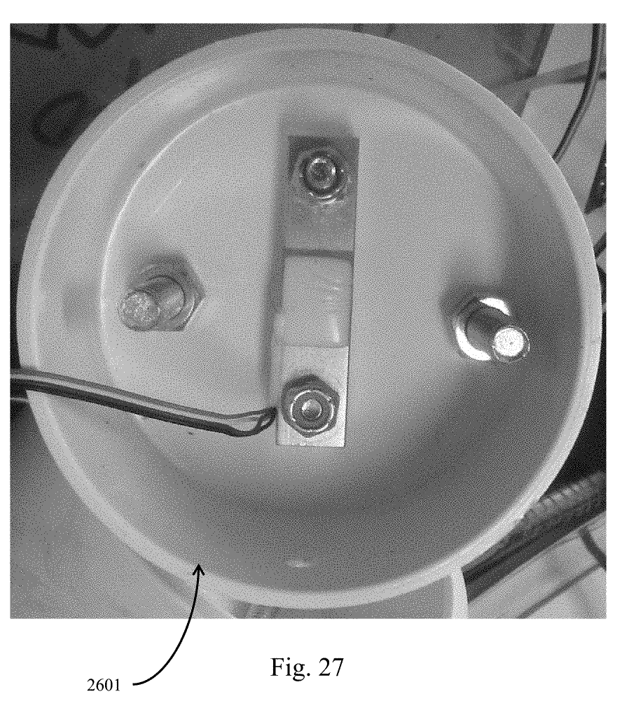

With reference now to FIGS. 26-27, a seventh exemplary embodiment of a water consumption sensor is depicted. Water consumption sensor 2600 includes outer casing 2601. Wall mount 2602 is a roughly semicircular loop adapted to fit over a hook, bolt, nail, or other mount point. Extending substantially vertically through outer casing 2601 is bucket retention arm 2603. Bucket retention arm 2603 includes a loop, which may be open or closed, which is adapted to receive a hook, carabiner, or other connector, and in turn retain a bucket handle. Bucket retention arm 2603 is coupled to a sensor, such as a cantilever sensor, as described further above.

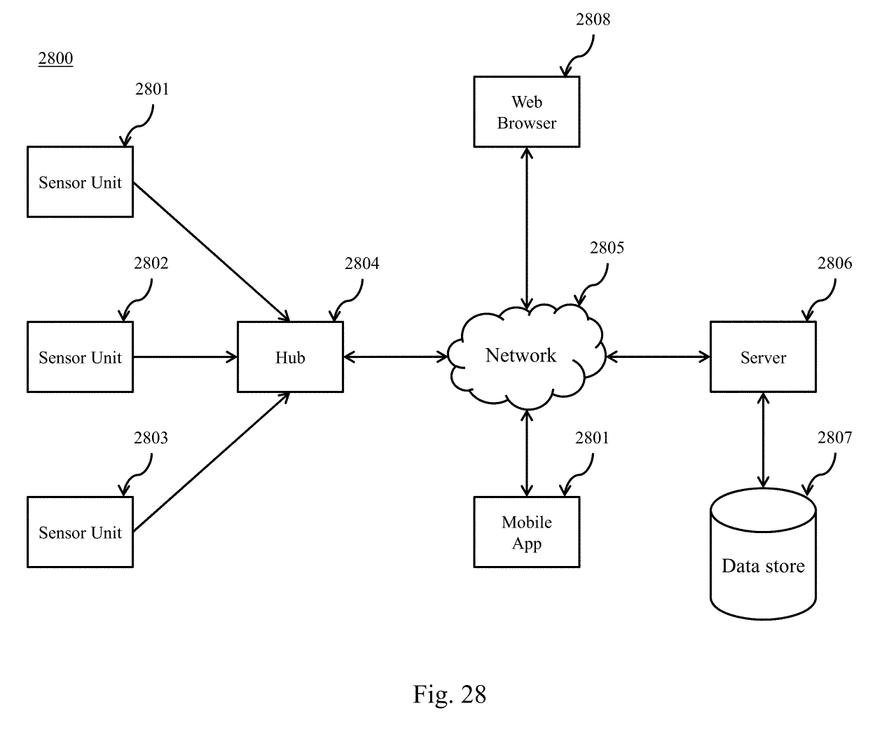

With reference now to FIG. 28, a system for water consumption monitoring according to embodiments of the present disclosure is illustrated. A plurality of sensor units 2801 . . . 2803 provide water consumption data to hub 2804. Hub 2804 in turn provides aggregated data to remote server 2806. In some embodiments, hub 2804 performs event detection and provides event information to server 2806. In some embodiments, hub 2804 communicates with server 2806 via a network such as the internet. Server 2806 may store data, including water consumption data and event detection data, in data store 2807. A user may receive aggregated water consumption data, alerts based on predetermined thresholds, or event detection data through, for example, a web browser 2808 or a mobile app 2801.

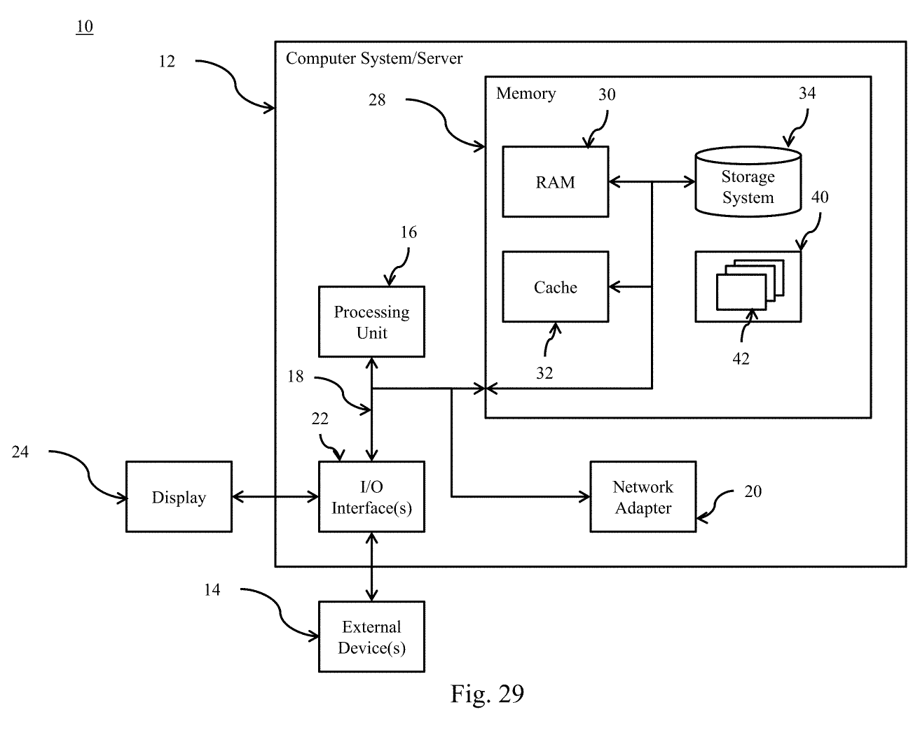

Referring now to FIG. 29, a schematic of an example of a computing node is shown. Computing node 10 is only one example of a suitable computing node and is not intended to suggest any limitation as to the scope of use or functionality of embodiments of the invention described herein. Regardless, computing node 10 is capable of being implemented and/or performing any of the functionality set forth hereinabove.

In computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 27, computer system/server 12 in computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A device comprising:
an outer casing separably coupled to a wall mount;
a bucket retention arm coupled to the wall mount and extending from the wall mount through the outer casing;
a cantilever sensor disposed within the outer casing and operably coupled to the bucket retention arm, the cantilever sensor being adapted to detect a force on the bucket retention arm;
a transmitter operably coupled to the cantilever sensor and adapted to transmit data regarding the force on the bucket retention arm.

2. The device of claim 1, wherein the bucket retention arm extends substantially perpendicular to the wall mount when unloaded.

3. The device of claim 1, wherein the bucket retention arm extends substantially parallel to the wall mount when unloaded.

4. The device of claim 1, wherein the outer casing is substantially rounded.

5. The device of claim 1, wherein the outer casing is substantially dome shaped.

6. The device of claim 1, wherein the outer casing is water resistant.

7. The device of claim 1, wherein the outer casing is watertight.

8. The device of claim 1, wherein the cantilever sensor and the transmitter are waterproof.

9. The device of claim 1, wherein the bucket retention arm comprises a closed loop or a hook.

10. The device of claim 1, wherein the outer casing comprises plastic, metal, ceramic, wood, or fiberglass.

11. The device of claim 1, further comprising an antenna disposed exterior to the outer casing.

12. The device of claim 1, wherein the wall mount comprises a mounting plate, a hook, or a loop.

13. The device of claim 1, wherein the bucket retention arm includes a recess to retain a bucket handle between the outer casing and the distal end of the retention arm.

14. The device of claim 1, wherein the retention arm extends about two inches or less from the outer casing.

15. The device of claim 1, wherein the transmitter is adapted to transmit water level readings according to a predetermine schedule.

16. The device of claim 1, wherein wherein the transmitted is adapted to transmit water level readings based on a current water level.

17. The device of claim 1, wherein the transmitter is adapted to transmit via radio or infrared.

18. The device of claim 1, wherein the outer casing has a depth of about three inches or less.

19. The device of claim 1, wherein the outer casing has a height of at least about four inches.

20. A system comprising:
a water consumption sensor, comprising
an outer casing separably coupled to a wall mount,
a bucket retention arm coupled to the wall mount and extending from the wall mount through the outer casing,
a cantilever sensor disposed within the outer casing and operably coupled to the bucket retention arm, the cantilever sensor being adapted to detect a force on the bucket retention arm, and
a transmitter operably coupled to the cantilever sensor and adapted to transmit data regarding the force on the bucket retention arm; and
a computing node comprising a human-readable display, the computing node being adapted to receive data transmitted by the water consumption sensor and to display an indicator of water consumption.
